(19) United States
(12) Patent Application Publication
(10) Pub. No.: US 2008/0120509 A1
(43) Pub. Date: May 22, 2008

(54) Biometrics-secured transaction card

(76) Inventor: Rodolphe J. Simon, Dexter, ME (US)

Correspondence Address: BOHAN, MATHERS & ASSOCIATES, LLC, PO BOX 17707, PORTLAND, ME, 04112-8707, US

(21) Appl. No.: 11/601,237

(22) Filed: Nov. 17, 2006

(51) Int. Cl. H04L 9/32

(52) U.S. Cl. 713/186

(57) ABSTRACT

Secure transaction card for execution of transactions by an authorized user. The secure transaction card has a biometric sensor, a battery, data transmission means, a microprocessor, a data storage device, and a security circuit. The microprocessor compares the scanned biometric feature with biometric data stored on the card. Upon determination of a match, the microprocessor energizes the security circuit, which then allows transmission of data to an external card reader. Data transmission is via a magnetic strip or RF technology. Upon determination of a mismatch, the security circuit remains de-energized and data transmission from or to an external reader is blocked.

### BACKGROUND INFORMATION

1. Field of the Invention

The invention relates to the field of electronically scanned transaction cards. More particularly, the invention relates to transaction cards encoded with biometric data for security purposes.

2. Description of the Prior Art

Financial institutions, governmental communities, businesses, hospitals and other such facilities require a means to execute transactions in a secure and expedited manner. Today, the electronically scanned magnetic strip card is typically used as a transaction card. This type of transaction card offers many advantages, It is inexpensive to manufacture, small enough to fit easily in a small wallet, lightweight, durable, and suitable for myriad applications. The magnetic strip card has been in use for decades now, worldwide, and a vast worldwide network of automated teller machines (ATMs) and other types of card processors exists for processing such cards. There are certain disadvantages, however, to using the conventional magnetic strip card. An authorized bearer of a magnetic strip card that is used for cash withdrawal at an ATM must remember extraneous information, such as a personal identification number (PIN) and/or password in order to execute a transaction. If the card bearer forgets the PIN and makes multiple attempts to complete the transaction, the card will generally be pulled into the ATM, to be retrieved in person only at the bank or entity that operates the particular ATM. This is a security measure to prevent what appears to be an unauthorized person from completing a transaction. This is an inconvenience for the authorized card bearer, because he now has to go the bank to retrieve his card or have a new card issued, which involves time and expense. In order to avoid such mishaps, the card bearer often writes the PIN on a slip of paper and keeps it in his wallet, in close proximity to the card itself. This defeats the purpose of having a PIN, which is to protect against unauthorized use, should the wallet fall into the hands of an unauthorized person. Furthermore, the traditional magnetic strip card offers little security should an authorized user be forced to execute a transaction under threat of bodily injury.

The magnetic strip card is also frequently used to transact business, whereby the only source of identification required is a comparison of the signature on the back of the card with a signature on a transaction slip. This provides very little security, because the person comparing the signatures frequently does so only superficially. Furthermore, signatures are easily forged. In some cases, a photo-ID is required to confirm the identity of the person named on the magnetic strip card. This security measure may be thwarted by a person, who changes his or her appearance to look like the image in the photo-ID.

Radio-frequency (RF) technology is widely used now for radio frequency identification (RFI) cards. RF technology is a contactless technology, that is, the data is transmitted via radio broadcast, and enables very fast data transmission, because the card does not need to come into contact with the card scanner, in order to transmit data. RFI cards are used in many different types of transactions, such as speed passes for highway toll booths or gas stations, product tracking, animal identification, etc. The RFI card is just as vulnerable to unauthorized use as is the magnetic strip card. RF technology has a greater weakness for misuse than the magnetic strip card, though, because information on RFI cards can be surreptitiously and fraudulently obtained by RF decryption equipment.

What is needed, therefore, is a transaction card that provides greater security without requiring a PIN or other extraneous information. What is further needed is such a transaction card that is adaptable for both magnetic strip and RF transactions. What is yet further needed is such a transaction card that limits fraudulent transactions executed under duress to small monetary amounts.

### BRIEF SUMMARY OF THE INVENTION

The present invention is a biometrics-secured transaction card that prevents any data transmission without an initial input of a biometric feature. The biometrics-secured transaction card comprises a card substrate, data storage device or devices for transactional data and for biometric data, a biometric sensor, a microprocessor, a power source, and a data-release circuit that enables/disables transmission of any data. The card contains stored biometric data, as well as transactional data. The biometric sensor is accessible on the outer surface of the card substrate and is powered by the power source. The biometric sensor sends sensed biometric data to the microprocessor, which compares that data with the stored biometric data. Upon determining a match between the sensed and the stored biometric data, the microprocessor energizes the data-release circuit, which then allows a card reader to read or receive transactional data.

When a match between sensed and stored biometric data is ascertained, the data-release circuit may be activated for a pre-programmed period of time that is deemed adequate to complete the intended transaction. Transactional data may be obtained from the biometrics-secured transaction card only while the circuit is energized. Once the circuit is de-energized, the transactional data, whether stored on a magnetic strip or in an RF transmitter, cannot be read by any scanning means. This provides a high level of security, without requiring the authorized card bearer to remember a PIN or password.

It is understood that data for any biometric feature may be stored on the card, such as a handprint, fingerprint, thumbprint, voiceprint, retinal scan, or DNA sequence. It is also understood that the invention is not limited in scope to a particular type of sensor, but rather, that any biometric sensor that is small enough to be incorporated on the card and with an output that is electronically connectable to at least the microprocessor on the card is suitable. For purposes of illustration, a fingerprint will hereinafter be used to indicate the biometric feature and a fingerprint sensor used to indicate the biometric sensor.

The microprocessor is encoded with fingerprint matching software that compares the sensed fingerprint against the stored fingerprint data to determine a match or a mismatch. If the fingerprint matching software determines a match, the microprocessor sends a signal that energizes the data-release circuit for a certain period of time, for example, approximately 40 seconds. The card scanner is able to access the transactional data stored on the card as long as the data-release circuit remains energized. If the fingerprint matching software determines a mismatch, the microprocessor does not energize the data-release circuit.

The microprocessor may include a single storage device for transactional and biometric data, or the storage device(s) may include separate components that are in communication with the microprocessor. The biometrics-secured transaction card according to the invention may also include data transmission both by magnetic strip and RF technology, or just magnetic strip data transmission or just RF data transmission, depending on the intended applications for the card. In any case, the microprocessor first determines a match between a sensed biometric feature and stored biometric data, before the data-release circuit is energized for a limited period of time, enabling a transaction to be completed within that period of time.

The biometrics-secured transaction card according to the invention also provides an additional fraud-limiting feature. Data for more than one biometric feature is included on the biometrics-secured transaction card, the first feature being the biometric feature required to execute any legitimate transaction with the card, the second feature being the biometric feature that limits the transaction that can be executed with the card. For example, the fingerprint of the first finger on the right hand is the biometric feature required to execute any legitimate transaction and the thumbprint of the right hand the biometric feature that limits the card to a particular fraud-limiting transaction. An authorized card bearer, who is being forced to authorize an ATM transaction under threat of bodily harms applies the thumbprint to the biometric sensor. This limits the transactions that can be executed, for example, a currency withdrawal transaction is limited to a pre-determined small monetary amount.

### BRIEF DESCRIPTION OF THE DRAWINGS

The present invention is described with reference to the accompanying drawings. In the drawings, like reference numbers indicate identical or functionally similar elements.

FIG. 1 is a front view of the biometrics-secured transaction card according to the invention, showing a biometrics sensor.

FIG. 2 is an illustration of the rear view of the card of FIG. 1, showing a magnetic strip and an RF transmitter.

FIG. 3 shows a layout of the various components embedded in the card substrate.

FIG. 4 is a block diagram of the biometrics-secured transaction card of FIG. 1.

FIG. 5 shows a battery pack for RF data transmission being inserted into the biometrics-secured transaction card according to the invention.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

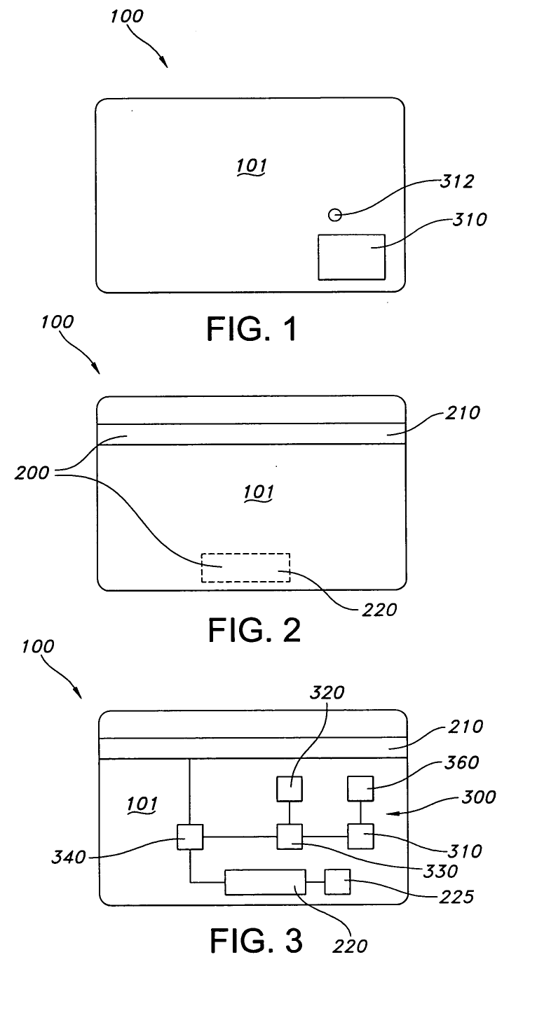

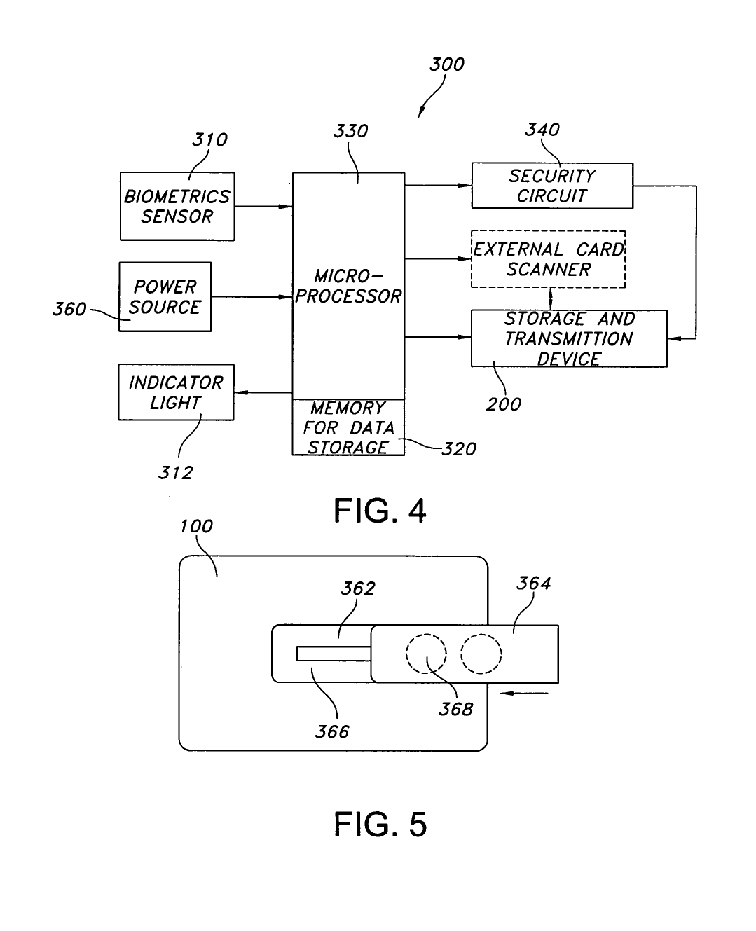

FIGS. 1 and 2 show the external faces of a biometrics-secured transaction card 100 according to the invention; FIG. 3 shows the various components arranged on the card; FIG. 4 is a block diagram of the components; and FIG. 5 illustrates a removable battery pack that is insertable into the biometrics-secured transaction card 100. FIGS. 1 and 2 show a blank card, that is, a card that has no text or images on the external surfaces. It is understood, however, that, depending on the intended use of the card, a credit card number or other identification number, identifying text, a photograph or other informative or decorative image may be visible on the card 100. The biometrics-secured transaction card 100 comprises a storage and transmission device 200 for transactional data and a biometric security circuit 300, both of which are embedded in a card substrate 101. The transactional data is that data required by an external system for completing some transaction, such as a cash withdrawal from an ATM, a security check for unlocking a door, etc. The storage and transmission device 200 is not limited to a particular technology, but rather, includes any known technology for storing and transmitting transactional data. Such technologies today include magnetic strip data storage, in which the data is stored on a magnetic strip 210 and read upon contact with an external magnetic strip scanner, and RF data transmission, in which the data is stored in a data storage device 225 and transmitted to an external scanner by an RF transmitter 220.

The biometric security circuit 300 comprises a biometric sensor 310, a microprocessor 330, a biometric-data storage device 320, a data-release security circuit 340, and a power source 360. The biometric sensor 310 is accessible on an external face of the card substrate 101 and is connected to a power source 360, so that the sensor 310 is ready for scanning a biometric feature at any time. The power source 360 is a long-life battery that is embedded into the card substrate 101 or is a replaceable battery-pack insert that is slid or snapped into place on the card substrate 101. FIG. 5 illustrates a battery pack 364 containing two replaceable button batteries 368. The batter pack 364 slides into a receiving channel 366 on the card substrate 101. A battery connector 362 is embedded into the substrate and provides the connection between the batteries 362 and the microprocessor (not shown). Suitable batteries are thin, or very thin button batteries or ribbon batteries. Examples of suitable batteries include the commercially available CR2016 Button Battery from Maxell and STD-4 Ribbon Battery from Power Paper. The power source 360 also supplies voltage to the microprocessor 330, which receives biometric data from the biometric sensor 310 and compares it with biometric data that is stored in the biometric data storage device 320. If the comparison indicates a match between the sensed and the stored biometric data, the microprocessor 330 energizes the security circuit 340, which in turn energizes the storage and transmission device 200. If a mismatch is determined, the microprocessor 330 does not energize the data-release circuit 340. In this case, the data stored in the storage and transmission device 200 cannot be read by the external scanner, be it a magnetic strip scanner or an RF scanner. The data-release circuit 340 may be any conventional electronic switch means that is suitable for use on a credit-card type device. Optionally, an indicator light 312 may be provided on one of the external surfaces of the card 100 which indicates a status of the card. For example. a steady red light may indicate a failed match attempt, a blinking red light a ready-to-read state, and a steady green light may indicate a successful match.

For purposes of illustration, the biometric sensor 310 in this embodiment is a fingerprint sensor. Fingerprint sensors are well known and any sensor that is suitable for incorporation onto the secure transaction card 100 may be used. An example of such a suitable fingerprint sensor is a FID-3001 fingerprint sensor from Fidelica Microsystems of Milpitas, Calif. A person desiring to obtain the biometrics-secured transaction card 100 according to the invention provides fingerprint data to the card issuer. This fingerprint data is stored in the storage and transmission device 320 on the card. To execute a transaction with the card 100, the card bearer applies the appropriate finger to the fingerprint sensor 310. The fingerprint sensor 310, energized by the power source 360, sends the sensed biometric data to the microprocessor 330, where it is compared with stored biometric data. Only upon determining a match is the data-release circuit 340 energized and the transactional data in the storage and transmission device 200 made available for scanning by an external card scanner. The data-release circuit 340 remains energized for only a pre-programmed period of time, such as 40, 60, or 80 seconds. Once the time has lapsed, the data-release circuit 340 is de-energized and the transactional data is then inaccessible to any external source.

An additional security feature of the biometrics-secured transaction card 100 is the storage of multiple biometric data sets; one or more full-access data sets being data sets that enable any legitimate transaction with the card; one or more limited-access data sets being data sets that enable only limited transactions with the card; and possibly an additional data set that allows no transactions to be executed. One example of use of a card with a full-access data set and a limited-access data set is that of a family ATM card. A fingerprint from the parent allows full access, a fingerprint from the child only limited access to funds in the bank account. A second example of a limited-access data set is for anti-fraud purposes. If the legitimate card bearer were forced to authorized use of the biometrics-secured transaction card 100 under threat of harm, he would apply a different finger to the fingerprint scanner that corresponds to the fingerprint data stored in the biometrics-secured transaction card as the limited-access data set. This would bring up information on the ATM, for example, that only a very small amount of money is available for withdrawal.

It is understood that the embodiments described herein are merely illustrative of the present invention. Variations in the construction of the secure transaction card may be contemplated by one skilled in the art without limiting the intended scope of the invention herein disclosed and as defined by the following claims.

What is claimed is:

1. An electronic transaction card comprising:
a card substrate;
a storage and transmission device;
stored transactional data; and
a biometric security circuit that includes stored biometric data, a biometric sensor, a data-release circuit, a microprocessor, and a power source;
wherein said microprocessor compares a biometric feature sensed by said biometric sensor with said stored biometric data, and, upon determination of a match between said sensed biometric feature and said stored biometric data, energizes said data-release circuit, which then enables transmission of said transactional data to an external data retrieval system; and
wherein said storage and transmission device and said biometric security circuit are incorporated into said card substrate.

2. The electronic transaction card of claim 1, wherein said data storage and transmission device includes a magnetic strip for data storage and transmission

3. The electronic transaction card of claim 2, wherein said stored biometric data is stored on said magnetic strip.

4. The electronic transaction card of claim 1, wherein said stored biometric data is stored in a memory in said microprocessor.

5. The electronic transaction card of claim 1, wherein said data storage and transmission device is an RF transmission device that transmits said transactional data.

6. The electronic transaction card of claim 1, wherein said power source is a battery pack that includes one or more replaceable batteries.

7. The electronic transaction card of claim 6, wherein said battery pack is an insert that carries said one or more replaceable batteries and said card substrate has a receiving channel and a connector for receiving said insert and providing a connection between said one or more replaceable batteries and said biometric security circuit.

8. The electronic transaction card of claim of claim 1, wherein said biometric sensor is a fingerprint sensor.

9. The electronic transaction card of claim 1, wherein said biometric data includes multiple sets of biometric data.

10. The electronic transaction card of claim 9, wherein a first set of biometric data enables a first range of transactions and a second set of biometric data enables a second range of transactions.

11. The electronic transaction card of claim of claim 1 further comprising an indicator light on an external surface of said card substrate, said indicator light indicating a read-status of said biometric security circuit.
